(19) United States
(12) Patent Application Publication
(10) Pub. No.: US 2014/0032098 A1
(43) Pub. Date: Jan. 30, 2014

(54) NAVIGATION DEVICE AND METHOD FOR GUIDING HIGH-OCCUPANCY VEHICLES

(71) Applicant: Eric A. Anderson, Olathe, KS (US)

(72) Inventor: Eric A. Anderson, Olathe, KS (US)

(73) Assignee: GARMIN SWITZERLAND GMBH, Schaffhausen (CH)

(21) Appl. No.: 13/559,277

(22) Filed: Jul. 26, 2012

(51) Int. Cl. G01C 21/36

(52) U.S. Cl. 701/428

(57) ABSTRACT

A navigation device comprises a display, a data storage element, a passenger sensor, and a processor. The display may communicate routing data to a driver of a vehicle. The data storage element may store cartographic data including high-occupancy vehicle (HOV) lane data. The passenger sensor may sense a number of passengers in the vehicle. The processor may be coupled with the display and the data storage element and may be configured to receive the number of sensed passengers in the vehicle, determine if the vehicle is eligible to travel through one or more HOV lanes based on the number of sensed passengers and HOV lane data, determine a route that includes the one or more HOV lanes if the vehicle is eligible to travel in the one or more HOV lanes, and provide a visual indication of the route to be shown on the display.

### BACKGROUND

Embodiments of the present technology relate to vehicle navigation. More particularly, embodiments of the present technology relate to devices that direct a driver of a vehicle to travel in high-occupancy vehicle (HOV) lanes, if appropriate.

### SUMMARY

Embodiments of the present technology provide a navigation device for determining a route that includes a high-occupancy vehicle (HOV) lane. The navigation device may broadly comprise a display, a data storage element, a passenger sensor, and a processor. The display may communicate routing data to a driver of a vehicle. The data storage element may store cartographic data including high-occupancy vehicle (HOV) lane data. The passenger sensor may sense a number of passengers in the vehicle. The processor may be coupled with the display and the data storage element and may be configured to receive data or signals representative of the number of sensed passengers in the vehicle, determine if the vehicle is eligible to travel through one or more HOV lanes based on the number of sensed passengers and HOV lane data, determine a route that includes the one or more HOV lanes if the vehicle is eligible to travel in the one or more HOV lanes, and provide a visual indication of the route to be shown on the display.

This summary is provided to introduce a selection of concepts in a simplified form that are further described below in the detailed description. This summary is not intended to identify key features or essential features of the claimed subject matter, nor is it intended to be used to limit the scope of the claimed subject matter. Other aspects and advantages of the present technology will be apparent from the following detailed description of the embodiments and the accompanying drawing figures.

### BRIEF DESCRIPTION OF THE DRAWING FIGURES

Embodiments of the present technology is described in detail below with reference to the attached drawing figures, wherein:

FIG. 1 is a schematic block diagram of a navigation device constructed in accordance with various embodiments of the present technology; and

FIG. 2 is a front view of the navigation device depicting a display of the navigation device.

The drawing figures do not limit the present technology to the specific embodiments disclosed and described herein. The drawings are not necessarily to scale, emphasis instead being placed upon clearly illustrating the principles of the technology.

### DETAILED DESCRIPTION

The following detailed description of the technology references the accompanying drawings that illustrate specific embodiments in which the technology can be practiced. The embodiments are intended to describe aspects of the technology in sufficient detail to enable those skilled in the art to practice the technology. Other embodiments can be utilized and changes can be made without departing from the scope of the present technology. The following detailed description is, therefore, not to be taken in a limiting sense. The scope of the present technology is defined only by the appended claims, along with the full scope of equivalents to which such claims are entitled.

In this description, references to “one embodiment”, “an embodiment”, or “embodiments” mean that the feature or features being referred to are included in at least one embodiment of the technology. Separate references to “one embodiment”, “an embodiment”, or “embodiments” in this description do not necessarily refer to the same embodiment and are also not mutually exclusive unless so stated and/or except as will be readily apparent to those skilled in the art from the description. For example, a feature, structure, act, etc. described in one embodiment may also be included in other embodiments, but is not necessarily included. Thus, the present technology can include a variety of combinations and/or integrations of the embodiments described herein.

Various embodiments of the present technology may include a navigation device for determining a route that includes a high-occupancy vehicle (HOV) lane. The HOV lane is typically implemented on a multi-lane highway or interstate and is reserved for vehicles with a minimum number of passengers. The HOV lane may be designated as “HOV-2”, or just “HOV”, which requires at least one passenger in addition to the driver, or “HOV-3”, which requires at least two passengers. Typically, the HOV lane is reserved only during weekdays at certain times of the day.

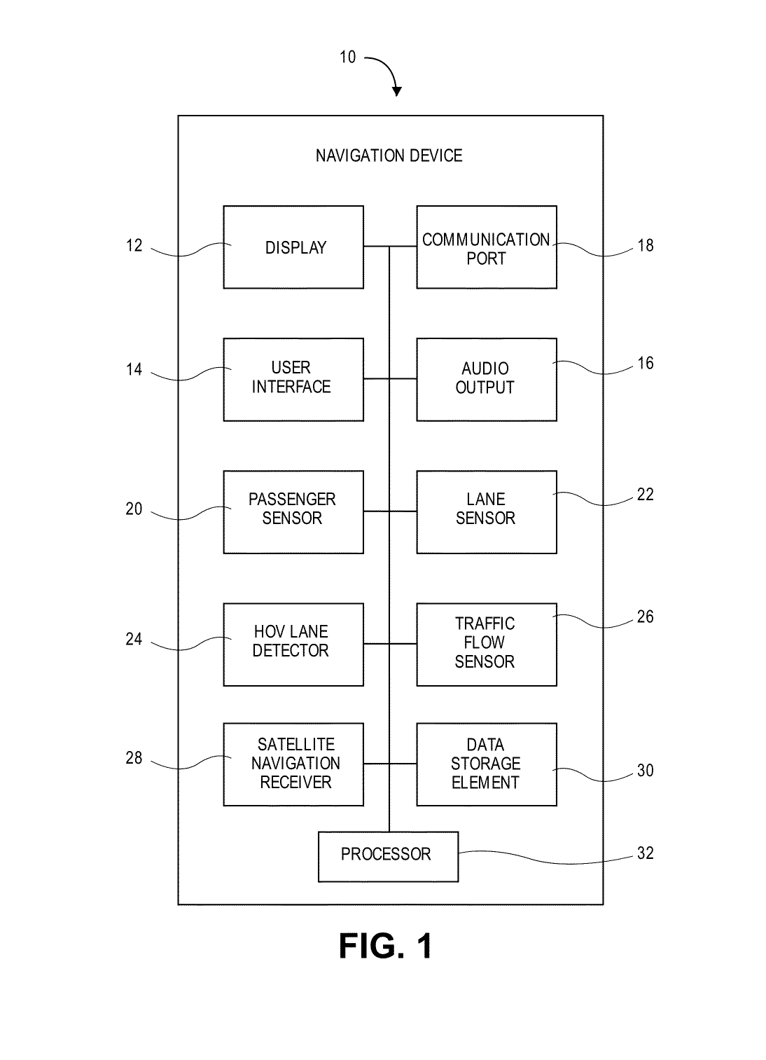

Embodiments of the technology will now be described in more detail with reference to the drawing figures. Referring initially to FIG. 1, a navigation device 10 is illustrated and may broadly comprise a display 12, a user interface 14, an audio output 16, a communication element 18, a passenger sensor 20, a lane sensor 22, a high-occupancy vehicle (HOV) lane detector 24, a traffic flow sensor 26, a satellite navigation receiver 28, a data storage element 30, and a processor 32.

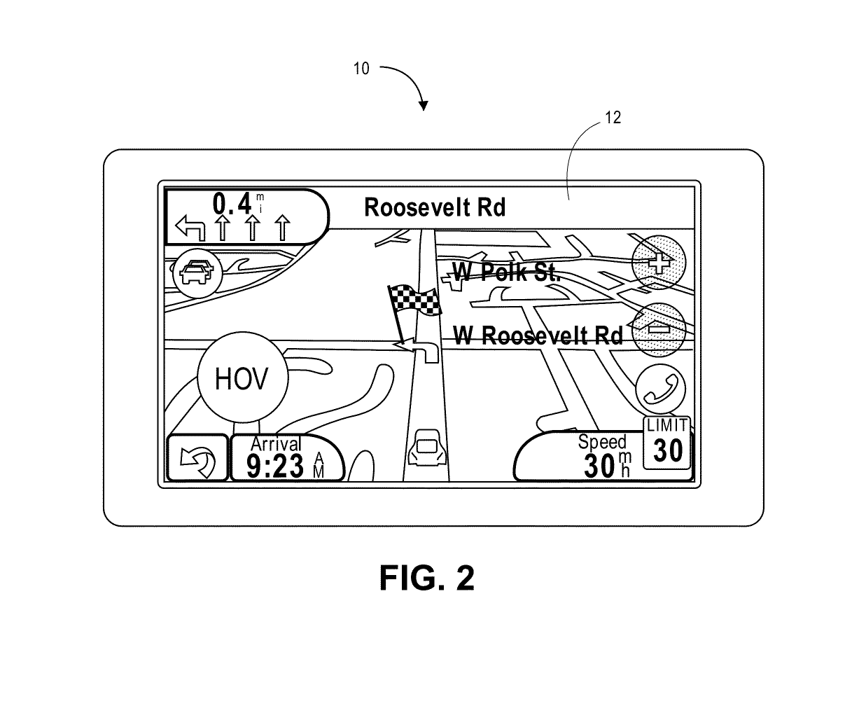

The navigation device 10 is generally used with vehicles, such as automobiles, vans, trucks, motorcycles, buses, or the like. The navigation device 10 may determine a route of travel given a starting location and a destination and may provide maps, directions, and/or routing instructions to a driver of the vehicle. The navigation device 10 may be positioned within forward view of the driver such as attached to the windshield, placed on the dashboard, positioned in the dashboard or the center console, or the like. An exemplary navigation device 10 is shown in FIG. 2. In some configurations, the navigation device 10 comprises a system having a plurality of discrete components. That is, the navigation device 10 is not necessarily contained within a single housing.

The display 12 may include video devices of the following types: plasma, light-emitting diode (LED), organic LED (OLED), Light Emitting Polymer (LEP) or Polymer LED (PLED), liquid crystal display (LCD), thin film transistor (TFT) LCD, LED side-lit or back-lit LCD, combinations thereof, or the like. The display 12 may possess a square or a rectangular aspect ratio and may be viewed in either a landscape or a portrait mode. Generally, the display 12 is integrated with the navigation device 10, as shown in FIG. 2, although in certain embodiments, the display 12 may be a separate component from the navigation device 10. The display 12 may show graphics, text, moving images, and combinations thereof. The display 12 may also show a route as determined by the processor 32, as well as maps or cartographic data, roadway views, street names, views of roadway signs, menus, lists of options and settings, on-screen keyboards and/or number pads, combinations thereof, and the like. The display 12 may receive a signal or data from the processor 32 that includes content to be shown on the display 12.

The user interface 14 generally allows the driver to interact with the navigation device 10. The user interface 14 may include knobs, jog dials, shuttle dials, switches, keypads, keyboards, mice, joysticks, microphones, combinations thereof, and the like. The user interface 14 may further include lights, meters, or secondary displays to indicate the status of the navigation device 10. In various embodiments, the display 12 may also include a touch screen occupying the entire display 12 or a portion thereof so that the display 12 functions as a portion of the user interface 14. The touch screen may allow the driver or a passenger to interact with the navigation device 10 by physically touching areas of the display 12. The driver or passenger may utilize the user interface 14 to input data or change settings of the navigation device 10. For example, the driver or passenger may use the user interface 14 to input a destination of travel. In addition, the driver or passenger may use the user interface 14 to change settings that affect, for example, the way maps are shown on the display 12 or the way a route is determined. In some embodiments, a microphone may be used to input data. The user interface 14 may also include a voice recognition processor that allows the driver or passenger to input data or change settings by using voice commands.

The audio output 16 may include one or more speakers, sound transducers, or the like, combinations thereof. The audio output 16 may provide routing instructions, such as turn directions, to the driver. The audio output 16 may also deliver other messages to the driver. The audio output 16 may utilize speech or voice synthesis, playback of prerecorded messages, or a combination of both.

The communication element 18 generally allows the navigation device 10 to communicate with external systems or devices. The communication element 18 may include signal and/or data receiving circuits and signal and/or data transmitting circuits. The communication element 18 may transmit and receive signals wirelessly and may include general radio frequency (RF) circuits, antennas, and the like. In various embodiments, the communication element 18 may include a radio such as a global system for mobile communications (GSM) radio. The communication element 18 may also transmit and receive signals and/or data utilizing communication standards such as Bluetooth™ or Institute of Electrical and Electronics Engineers (IEEE) 802.11 standards. The communication element 18 may be configured to cellular connectivity with one or more cellular communication networks. Alternatively, or in addition, the communication element 18 may transmit and receive signals and/or data through wired media and may include connectors or couplers to receive metal conductor cables or connectors or optical fiber cables. Exemplary communication elements 18 may include a universal serial bus (USB) port, or the like. The communication element 18 may be utilized to download settings or data, such as maps or cartographic data, as well as upload data, such as routes that have been traveled.

The passenger sensor 20 generally senses or determines the number of passengers that are traveling in the vehicle and provides data or signals representative of the number to the processor 32. The passenger sensor 20 may be implemented in various ways. In some embodiments, the passenger sensor 20 may include at least one camera that periodically or continuously takes visible spectrum images of the vehicle cabin. The camera may be positioned within the cabin to have a view of the front and rear passengers. Thus, the camera may be mounted on the dashboard or the rear deck, or in an overhead location such as the dome light or along the edges or corners of the headliner of the vehicle. The camera may include processing components such as hardware, firmware, and/or software that perform human recognition in order to sense the number of passengers in the vehicle. Utilizing the processing components, the passenger sensor 20 may determine the presence of a passenger by detecting passenger movement, by comparing a current image with a stored image of an “empty” seat, by comparing a current image with a stored image of an “occupied” seat, through facial recognition algorithms, through conventional algorithms employed by the MICROSOFT KINECT device, combinations thereof, and the like.

In other embodiments, the passenger sensor 20 may include an infrared (IR) or thermal imaging camera or device. The IR camera may detect heat, and may interpret elevated temperatures in certain areas of the vehicle cabin as passengers. Thus, the IR camera may include hardware, firmware, and/or software that process infrared imagery.

In yet other embodiments, the passenger sensor 20 may include one or more pressure sensors. The pressure sensors may be positioned in one or more of the passenger seats of the vehicle and may detect the weight of a passenger. If a pressure sensor detects a weight over a given value, then the pressure sensor may determine that a passenger is sitting in the seat. Furthermore, the pressure sensor may detect the type of passenger based on the weight. For example, passengers with a weight in a certain range may be considered children, while passengers over a certain weight may be considered adults.

In yet other embodiments, the passenger sensor 20 may include a microphone, electric field monitor, or magnetic sensor to detect the presence of the passenger. For example, the passenger sensor 20 may detect the presence of the passenger by detecting the passenger's heart beat, electrical field, magnetic field, or other body characteristics.

In certain embodiments, the passenger sensor 20 may include a data interface in addition to or instead of the other embodiments of the passenger sensor 20. The data interface may communicate with an electronic data bus, such as the on-board diagnostics (OBDII) or the controller area network (CAN) bus, that exists within most vehicles. Pressure sensors may already exist in the vehicle passenger seats which communicate data over the vehicle data bus regarding the number of passengers. The data interface of the passenger sensor 20 may couple with the vehicle data bus and may receive data about the number of passengers in the vehicle. Such a configuration eliminates the need for the device 10 to include an additional camera or pressure sensor.

The lane sensor 22 generally detects the lane of the roadway in which the vehicle is traveling and provides the lane information to the processor 32. The lane sensor 22 may be implemented in various ways. In some embodiments, the lane sensor 22 may include at least one camera that periodically or continuously takes visible spectrum images of the roadway. The camera may be positioned on the underbody of the vehicle facing the roadway surface. In some configurations, the camera may be disposed in the vehicle's side mirrors, or any other location in, on or near a vehicle, to detect lane changes. The camera may include processing components such as hardware, firmware, and/or software that perform recognition in order to sense the lane markers on the roadway. For example, the camera may be able to detect solid or broken yellow or white lines and may be able to determine the lane based on the lines. In some embodiments, the navigation device 10 may utilize the satellite navigation receiver 28, as described in more detail below, for the lane sensor 22. The satellite navigation receiver 28 in combination with cartographic data may determine the lane in which the vehicle is traveling. In some configurations, the processor 32 includes the lane sensor 22 and the processor 32 is operable to sense the lane of the road in which the vehicle is traveling by comparing a current geographic location of the vehicle with the stored cartographic data.

The HOV lane detector 24 generally detects HOV lane indicators while the vehicle is traveling along the route and provides HOV lane information to the processor 32. Generally, the navigation device 10 may rely primarily on the cartographic data stored in the data storage element 30 to determine if and when HOV lanes are available along the route. However, cartographic data needs to be updated on a regular basis in order to track changes to roadways. In some instances, HOV lanes may be added to a road before the cartographic data is updated. Therefore, the navigation device 10 may also rely on the HOV lane detector 24 to determine HOV lane availability. In some situations, where a HOV lane is not geographically separated from a main roadway, the HOV lane detector 24 may be used to determine when the vehicle is not positioned within the HOV lane without reliance on the satellite navigation receiver 28. Such functionality enables routing via the HOV lane in situations where stored cartographic data indicates the presence of the HOV lane but where the satellite navigation receiver 28 is unable to resolve a position with sufficient accuracy to place the vehicle inside, or outside, the HOV lane.

The HOV lane detector 24 may include at least one camera or sensor that periodically or continuously takes visible spectrum images of roadway signs or the roadway surface. The camera may include processing components such as hardware, firmware, and/or software that perform recognition in order to sense roadway signs or markings on the roadway surface. For example, the camera may be able to detect roadway signs that indicate HOV lanes are available. Or, the camera may be able to detect that HOV lane markings, such as diamonds, are present on the roadway surface. In some configurations, the camera may detect HOV entry and exit markings to determine when it is appropriate to guide the vehicle into, and out of, HOV lanes.

In some configurations, the HOV lane detector 24 and lane sensor 22 may comprise the same components and perform the same functions. For example, the HOV lane detector 24 and lane sensor 22 may be embodied as a single camera that is operable to detect lane and HOV markings. That is, the lane sensor 22 may function as the HOV lane detector 24 by differentiating between normal lanes and HOV lanes.

The traffic flow sensor 26 generally determines the rate of flow of traffic along the route along which the vehicle is traveling and provides the rate of flow data to the processor 32. The traffic flow sensor 26 may include or may communicate with an RF receiver that receives reports of traffic flow rates or traffic congestion. The reports may include traffic flow rates for both HOV lanes and non-HOV lanes. The traffic flow sensor 26 may provide the traffic flow rate data for the HOV lanes and the non-HOV lanes to the processor 32. For example, the traffic flow sensor 26 may include a RDS-TMC or HD Radio traffic receiver operable to receive real-time traffic broadcasts. In some configurations, the traffic flow sensor 26 may include the communication element 18 and be operable to receive traffic flow information through one or more wireless data networks, such as a cellular data network.

The satellite navigation receiver 28 generally determines the geolocation of the vehicle. The satellite navigation receiver 28 may include a global positioning system (GPS) receiver, a satellite navigation receiver (e.g., GLONASS), a cellular signal receiver, an RF triangulation processor, an enhanced positioning system such as real time kinematic (RTK), or combinations thereof. The satellite navigation receiver 28 may supply the geolocation of the vehicle to the processor 32. The processor 32 may utilize the geolocation of the vehicle to verify whether the vehicle is following the determined route. In addition, the processor 32 may utilize the geolocation of the vehicle to compare with known geolocations of roadway lanes from cartographic data to determine the lane in which the vehicle is traveling.

The data storage element 30 may include data storage components such as random-access memory (RAM), read-only memory (ROM), hard-disk drives, optical disk drives, flash memory drives, and the like, or combinations thereof. The data storage element 30 may include, or may constitute, a “computer-readable medium”. The data storage element 30 may store the instructions, code, software, programs, applications, apps, or the like that are executed by the processor 32. In addition, the data storage element 30 may store cartographic data, as is known, as well as databases of points of interest and the like associated therewith. The cartographic data may also include indications of entry points and exit points to the HOV lanes. Furthermore, the data storage element 30 may store routes that the vehicle has traveled or other historical data such as the average speed, the maximum speed, the duration of a trip, the number of passengers per trip, and the like. In some embodiments, the data storage element 30 may communicate only with the processor 32. In other embodiments, the data storage element 30 may communicate with all of the components of the navigation device 10.

The processor 32 may include microprocessors, microcontrollers, digital signal processors (DSPs), field-programmable gate arrays (FPGAs), application-specific integrated circuits (ASICs), and the like, or combinations thereof. The processor 32 may generally execute, process, or run instructions, code, software, programs, applications, apps, or the like, or may step through states of a finite-state machine. The processor 32 may receive data, signals, or other inputs from the passenger sensor 20, the lane sensor 22, the HOV lane detector 24, the data storage element 30, the user interface 14, and the communication element 18. The processor 32 may send outputs to the display 12, the audio output 16, the data storage element 30, and the communication element 18.

Based on user input, the processor 32 may determine or calculate a route from a source location to a destination. For example, the driver may utilize the user interface 14 to input a destination. Generally, the processor 32 considers the current location of the vehicle to be the source location. The processor 32 may utilize cartographic data stored in the data storage element 30 to determine the route based on various settings or user input for preferences regarding of the route, such as the shortest route, the quickest route, routes that avoid toll roads, etc. In some configurations, the processor 32 may use the A* algorithm or other shortest-route algorithms to determine the route.

The processor 32 may check the input from the HOV lane detector 24 to determine if the route includes a road, such as a highway or interstate, with at least one HOV lane. The HOV lane detector 24, in this case, may be a portion of the data storage element 30 that includes data on HOV lanes. If there is at least one HOV lane along the route, then the processor 32 may further consider entry points and exit points from the HOV lane as supplied from the HOV lane detector 24. If there is at least one entry point and exit point from the HOV lane along the route, then the processor 32 may check the input from the passenger sensor 20. In some configurations, the processor 32 may check the input from the passenger sensor 20 first and then search for HOV lanes along the route. If the passenger sensor 20 indicates that there are enough passengers to travel in the HOV lane, then the processor 32 may include the HOV lane in the route and may provide a prompt to the display 12 that indicates the HOV lane. An example of the prompt on the display 12 is shown in FIG. 2, in which “HOV” appears as a pop-up indicator. Otherwise, the processor 32 may not include the HOV lane in the route.

In some embodiments, when an HOV lane is available and there are no passengers in the vehicle, the processor 32 may provide a prompt to the display 12, such as a pop-up message or other visual indication, to alert the driver that an HOV lane is available and that carpooling would allow the vehicle to be eligible to take advantage of the HOV lane.

The processor 32 may monitor the input from the passenger sensor 20 at regular intervals. If, during the trip, the vehicle acquires passengers or drops passengers off, then the processor 32 may alter the route accordingly. For example, if the vehicle was previously eligible to travel in the HOV lane and a sufficient number of passengers are dropped off to no longer qualify for the HOV lane, then the processor 32 may redetermine the route to no longer include the HOV lane and may prompt the user accordingly. Alternatively, if the vehicle was previously ineligible to travel in the HOV lane but stops to acquire passengers, then the processor 32 may redetermine the route to include the HOV lane and may prompt the user accordingly.

The processor 32 may also monitor the input from the HOV lane detector 24 at regular intervals. If the cartographic data stored in the data storage element 30 does not indicate that an HOV lane is available for the route and the HOV lane detector 24 determines that an HOV lane is available while the vehicle is traveling along the route, then the processor 32 may check the input from the passenger sensor 20. If the passenger sensor 20 indicates that there are enough passengers to travel in the HOV lane, then the processor 32 may redetermine the route include the HOV lane and may prompt the driver accordingly.

While traveling along the route, the processor 32 may check the input from the lane sensor 22 to determine the lane in which the vehicle is traveling. If the vehicle is traveling in the HOV lane and it was determined that the vehicle was eligible to travel in the HOV lane, then the processor 32 may do nothing. However, if the vehicle is not traveling in the HOV lane and it was eligible to do so, then the processor 32 may provide a prompt to the display 12 to alert the driver that an HOV lane is available. The processor 32 may also provide a prompt to the audio output 16 to alert the driver that an HOV lane is available.

In addition, if the vehicle is traveling in the HOV lane and it was determined that the vehicle was eligible to travel in the HOV lane, then the processor 32 may do nothing. However, if the vehicle is not traveling in the HOV lane and it is eligible to do so, then the processor 32 may check the input from the traffic flow sensor 26 to determine the rate of traffic flow for the HOV lane versus the non-HOV lanes. If traffic is flowing more quickly in the non-HOV lanes, then the processor 32 may do nothing. If traffic is flowing more quickly in the HOV lane, then the processor 32 may provide a prompt to the display 12 to alert the driver that an HOV lane is available and that the traffic is flowing more quickly in the HOV lane. The processor 32 may also provide a prompt to the audio output 16. In various embodiments, the processor 32 may further calculate the amount of time that might be saved by traveling in the HOV lane and may provide that data to the display 12.

Furthermore, if the vehicle is traveling in the HOV lane and it was determined that the vehicle is not eligible to travel in the HOV lane, then the processor 32 may provide a prompt to the display 12 to alert the driver that the vehicle is traveling in the HOV lane and is not eligible to do so. The processor 32 may also provide a prompt to the audio output 16.

In some embodiments, the processor 32 may analyze historical data stored in the data storage element 30 regarding routes that the vehicle has traveled in order to predict the route that is to be traveled without the driver having to enter a destination. Thus, the processor 32 may automatically provide to the display 12 maps and driving directions for the destination. The processor 32 may analyze routes traveled at various times of the day, routes traveled on various days of the week, the number of passengers included per trip, and the like. Accordingly, the processor 32 may predict the route that is to be traveled based on various parameters such as the day of the week, the time of day, the number of passengers, etc. For example, on a weekday morning, the processor 32 may check the input from the passenger sensor 20. If there are no passengers, the processor 32 may predict that the destination is the driver's place of work. For a weekday afternoon or evening with no passengers, the processor 32 may predict that the destination is the driver's home. If the current status of the number of passengers for a given time of day or day of the week does not match historical patterns, then the processor 32 may not predict the destination.

In some embodiments, the processor 32 may check the input from the passenger sensor 20 in order to enable certain functionality of the navigation device 10 that is not normally available to drivers. For example, if the passenger sensor 20 detects that there is at least one passenger in the vehicle, then the processor 32 may allow the user interface to be accessed while the vehicle is in motion. The processor 32 may allow on-screen keyboards or other inputs to be used by a passenger. The processor 32 may also allow images or information not intended for the driver to be shown on the display 12. In other embodiments, the processor 32 may send a signal or data through the communication element 18 to other devices or systems that at least one passenger is in the vehicle. Upon receipt of the signal, devices such as video players may allow videos to be displayed.

In some embodiments, the processor 32 may check the input from the passenger sensor 20 in order to display points of interest based on the number of passengers in the vehicle. For example, if there is at least one passenger in the vehicle, the processor 32 may provide to the display 12 points of interest that are more social in nature when the driver or the passenger performs a search for point of interest. Alternatively or in addition, the processor 32 may automatically provide to the display 12 points of interest that are more social in nature. In other embodiments, if the passenger sensor 20 can detect the type of passenger in the vehicle (based, for example, on the weight of the passenger), then the processor 32 may provide to the display 12 points of interest that are more kid-friendly in nature.

Embodiments of the navigation device 10 may operate as follows. The navigation device 10 may include default settings for determining a route to a destination. In addition, the driver may set his own preferences for determining a route before using the navigation device 10. At the beginning of a trip, the driver may enter the destination for the trip into the navigation device 10 utilizing the user interface 14. The driver may use physical keypads, rotary controllers, on-screen keyboards, voice commands, or combinations thereof. The processor 32 may utilize cartographic data stored in the data storage element 30 to determine a route based on settings or driver preferences. The processor 32 may check the input from the HOV lane detector 24 to determine if the route includes a road with at least one HOV lane with entry and exit points along the route. If there is at least one HOV lane with entry and exit points along the route, then the processor 32 may check the input from the passenger sensor 20. In some configurations, the input from the passenger sensor 20 may be checked first and then the processor 32 may search for HOV lanes along the route. If the passenger sensor 20 indicates that there are enough passengers to travel in the HOV lane, then the processor 32 may include the HOV lane in the route. If there are not enough passengers in the vehicle to be eligible for the HOV lane, then processor 32 may determine a route that does not include the HOV lane. Generally, the processor 32 provides to the display 12, as shown in FIG. 2, the route as well as maps, roadway views from various perspectives, driving directions, turn instructions, text messages, pop-up information, and the like, as well as combinations thereof. The processor 32 may also provide to the audio output 16 driving directions, turn instructions, or other information.

While traveling along the route, the processor 32 may check the input from the various sensors and may redetermine the route and/or alert the driver to status changes accordingly. The input from the lane sensor 22 may be checked to determine the lane in which the vehicle is traveling. In some configurations where the processor 32 is the lane sensor 22, the processor may determine the lane in which the vehicle is traveling by utilizing the current geographic location of the vehicle, such as by comparing the current geographic position of the vehicle with cartographic data such as geographic lane information. If the vehicle is not traveling in the HOV lane and it was determined that the vehicle was eligible to travel in the HOV lane, then the driver may be alerted that an HOV lane is available. Alternatively, if the vehicle is traveling in the HOV lane and it was determined that the vehicle is not eligible to travel in the HOV lane, then the driver may be alerted that the vehicle is traveling in the HOV lane and is not eligible to do so.

The input from the traffic flow sensor 26 may be checked to determine the rate of traffic flow for the HOV lane versus the non-HOV lanes. If traffic is flowing more quickly in the HOV lane, and if the processor 32 determines that the vehicle is HOV eligible, then the driver may be alerted that an HOV lane is available and that the traffic is flowing more quickly in the HOV lane.

The input from the passenger sensor 20 may be checked to determine the number of passengers. If the vehicle acquires or drops off passengers before the trip is complete, then the processor 32 may redetermine the route to include or exclude the HOV lane based on input from the passenger sensor 20.

The input from the HOV lane detector 24 may be checked to determine if the route includes an HOV lane which was not included in the cartographic data stored in the data storage element 30. If the HOV lane detector 24 senses a previously unknown HOV lane, then the processor 32 may, if appropriate, redetermine the route to include HOV lane and may alert the driver.

Although the technology has been described with reference to the embodiments illustrated in the attached drawing figures, it is noted that equivalents may be employed and substitutions made herein without departing from the scope of the technology as recited in the claims.

Having thus described various embodiments of the technology, what is claimed as new and desired to be protected by Letters Patent includes the following:

1. A navigation device comprising:
a display to communicate prompts to a driver of a vehicle;
a data storage element configured to store cartographic data including high-occupancy vehicle (HOV) lane data; and
a processor coupled with the display and the data storage element and configured to—
receive an input representative of a number of sensed passengers in the vehicle,
receive an input representative of a sensed lane of a road in which the vehicle is traveling,
determine if the vehicle is eligible to travel through one or more HOV lanes based on the number of sensed passengers and the HOV lane data,
determining, based on the sensed lane input, if the vehicle is currently traveling through a HOV lane, and
provide a prompt to the display that one or more HOV lanes are available if the vehicle is eligible to travel through the one or more HOV lanes but is not currently traveling through a HOV lane.

2. The navigation device of claim 1, wherein the processor is further configured to provide a prompt to the display that one or more HOV lanes are available and that an additional number of passengers would allow the vehicle to be eligible to travel in the HOV lane if vehicle does not meet a requirement for the one or more HOV lanes.

3. The navigation device of claim 1, wherein the processor is further configured to
provide an instruction to the display to navigate the vehicle in the one or more HOV lanes if the vehicle is eligible to travel through the one or more HOV lanes and if the vehicle is not in the one or more HOV lanes.

4. The navigation device of claim 1, wherein the processor is further configured to
provide an instruction to the display to navigate the vehicle out of the one or more HOV lanes if the vehicle is in the one or more HOV lanes and it does not meet a requirement for the one or more HOV lanes.

5. The navigation device of claim 1, wherein the processor is further configured to
determine entry points to and exits points from the one or more HOV lanes, and
provide a prompt to the display if at least one entry point and one exit point are available for travel.

6. The navigation device of claim 1, wherein the processor is further configured to
receive a rate of traffic flow for the one or more HOV lanes and the non-HOV lanes,
determine an amount of time saved by traveling in the one or more HOV lanes if the rate of traffic flow for the one or more HOV lanes is greater than the rate of traffic flow for the non-HOV lanes, and
provide a prompt to the display with the amount of time saved by traveling in the one or more HOV lanes if the vehicle is eligible to travel through the one or more HOV lanes and if the vehicle is not in the one or more HOV lanes.

7. The navigation device of claim 1, further comprising a passenger sensor to sense the number of passengers in the vehicle.

8. The navigation device of claim 7, wherein the passenger sensor includes a component selected from the group consisting of a camera, an infrared sensor, and a pressure sensor.

9. The navigation device of claim 1, further comprising a lane sensor to sense a lane of the road in which the vehicle is traveling.

10. The navigation device of claim 1, further comprising an HOV lane detector to detect HOV lane indicators while the vehicle is traveling along the route.

11. The navigation device of claim 1, further comprising a traffic flow sensor to determine a rate of flow of traffic.

12. A navigation device comprising:
a display to communicate prompts to a driver of a vehicle;
a lane sensor to sense a lane of a road in which the vehicle is traveling;
a data storage element configured to store cartographic data including high-occupancy vehicle (HOV) lane data; and
a processor coupled with the display and the data storage element and configured to—
receive an input representative of a number of sensed passengers in the vehicle,
receive an input representative of the sensed lane of the road in which the vehicle is traveling,
determine if the vehicle is eligible to travel through one or more HOV lanes based on the number of sensed passengers and HOV lane data,
provide a prompt to the display that one or more HOV lanes are available if the vehicle is eligible to travel through the one or more lanes but is not currently traveling through a HOV lane.

13. The navigation device of claim 12, wherein the processor is further configured to provide an instruction to the display to navigate the vehicle out of the one or more HOV lanes if the vehicle is in the one or more HOV lanes and it does not meet a requirement for the one or more HOV lanes.

14. The navigation device of claim 12, wherein the processor is further configured to
determine entry points to and exits points from the one or more HOV lanes, and
provide a prompt to the display if at least one entry point and one exit point are available for travel.

15. The navigation device of claim 12, wherein the processor includes the lane sensor and the processor is operable to sense the lane of the road in which the vehicle is traveling by comparing a current geographic location of the vehicle with the stored cartographic data.

16. The navigation device of claim 12, further comprising a passenger sensor to sense the number of passengers in the vehicle, wherein the passenger sensor includes a component selected from the group consisting of a camera, an infrared sensor, and a pressure sensor.

17. A navigation device comprising:
a display to communicate prompts to a driver of a vehicle;
a lane sensor to sense a lane of a road in which the vehicle is traveling;
a traffic flow sensor to determine a rate of flow of traffic;
a data storage element configured to store cartographic data including high-occupancy vehicle (HOV) lane data; and
a processor coupled with the display and the data storage element and configured to—
receive an input representative of a number of sensed passengers in the vehicle,
receive an input representative of the sensed lane of the road in which the vehicle is traveling,
determine if the vehicle is eligible to travel through one or more HOV lanes based on the number of sensed passengers and HOV lane data,
receive an input representative of a rate of traffic flow for the one or more HOV lanes and the non-HOV lanes,
determine an amount of time saved by traveling in the one or more HOV lanes if the rate of traffic flow for the one or more HOV lanes is greater than the rate of traffic flow for the non-HOV lanes,
provide a prompt to the display that one or more HOV lanes are available if the vehicle is eligible to travel through the one or more HOV lanes but is not currently traveling through a HOV lane, and
provide a prompt to the display with the amount of time saved by traveling in the one or more HOV lanes if the vehicle is eligible to travel in the one or more HOV lanes and if the vehicle is not in the one or more HOV lanes.

18. The navigation device of claim 17, wherein the processor is further configured to provide a prompt to the display that one or more HOV lanes are available and that an additional number of passengers would allow the vehicle to be eligible to travel in the HOV lane if vehicle does not meet a requirement for the one or more HOV lanes.

19. The navigation device of claim 17, wherein the processor is further configured to provide an instruction to the display to navigate the vehicle out of the one or more HOV lanes if the vehicle is in the one or more HOV lanes and it does not meet a requirement for the one or more HOV lanes.

20. The navigation device of claim 17, further comprising a passenger sensor to sense the number of passengers in the vehicle, wherein the passenger sensor includes a component selected from the group consisting of a camera, an infrared sensor, and a pressure sensor.
